(19) United States
(12) Patent Application Publication
(10) Pub. No.: US 2021/0140430 A1
(43) Pub. Date: May 13, 2021

(54) MULTI-STAGE ROTARY PISTON PUMP

(71) Applicant: Leybold GmbH, Köln (DE)

(72) Inventors: Thomas DREIFERT, Kerpen (DE); Roland MÜLLER, Köln (DE)

(21) Appl. No.: 16/617,355

(22) PCT Filed: May 23, 2018
(86) PCT No.: PCT/EP2018/063572

§ 371 Date: Nov. 26, 2019

(30) Foreign Application Priority Data
Jun. 17, 2017 (DE) 20 2017 003 212.0

(51) Int. Cl. F04C 25/02; F04C 29/04

(52) U.S. Cl. CPC F04C 25/02; F04C 18/165; F04C 29/04

(57) ABSTRACT

A multi-stage rotary piston pump comprising two shafts in a housing, which support multiple rotary pistons. Corresponding rotary pistons form a respective rotary piston pair, wherein multiple rotary piston pairs are provided which form a respective pump stage. Neighboring pump stages are each connected to one another via connection channels. The multi-stage rotary piston pump also comprises a pump inlet that is connected to the first pump stage, as well as a pump outlet that is connected to the last pump stage. The built-in volume ratio is at least 15, so that high pumping capacities of at least 1500 m³/h can be achieved.

### BACKGROUND

### 1. Field of the Disclosure

The disclosure relates to a multi-stage rotary piston pump.

### 2. Discussion of the Background Art

Rotary piston pumps usually comprise two-toothed rotary pistons arranged in a pump chamber. Further, multi-toothed rotary pistons having three or four teeth, for example, are known. The two rotary pistons are driven in opposite directions such that, through the individual chambers formed, a gas is taken in through an inlet and discharged through an outlet. In multi-stage rotary piston pumps, a plurality of such rotary piston pairs are arranged in series. The outlet of a pump stage is connected to the inlet of the succeeding pump stage.

For evacuating large lock chambers or other large chambers, a large amount of gas must be pumped. This must frequently be carried out within short periods of time. For this purpose, it is known to provide rotary piston pumps in combination with downstream series-connected prevacuum pumps. Such systems are also used when large gas flows have to be continuously pumped, wherein this is in particular carried out at low intake pressures of below 20 mbar (absolute).

Usually, nowadays combinations of rotary piston pumps and prevacuum pumps having a correspondingly high pumping capacity are used for pumping large amounts of gas.

Known commercially available multi-stage rotary piston pumps have a pumping capacity of approximately 600 m³/h. The pumps of Kashiyama with the type designation SD600C, for example, have such a pumping capacity. Usually, large screw or multi-stage rotary piston pumps are used as prevacuum pumps in these pump systems.

It is an object of the disclosure to provide a multi-stage rotary piston pump where the combination of rotary piston and prevacuum pump can be replaced by one rotary piston pump having a comparable pumping capacity.

### SUMMARY

Generally, there is the problem that in the case of large vacuum pumps having a correspondingly large pumping capacity the ratio of the internal surfaces to the delivery volume or the throughput is unfavorable. As a result, high temperatures occur in such pumps. High temperatures result in a large heat expansion. In the case of multi-stage rotary piston pumps, the heat expansion caused by the high temperature occurs in particular in the axial direction such that the rotary pistons are displaced axially, i.e. in the longitudinal direction of the axis supporting the rotary piston. As a result, the pump chambers, where the rotary pistons are arranged, would have a correspondingly large axial gap. However, this, in turn, would have a negative effect on the pump output and thus the temperature.

The multi-stage rotary piston pump according to the disclosure comprises two shafts arranged in a housing, said shafts supporting a plurality of rotary pistons. Here, the rotary piston can also be integrally formed with the respective shaft. Corresponding rotary pistons respectively make up a rotary piston pair, wherein a plurality of rotary piston pairs are provided which respectively make up a pump stage. Neighboring pump stages are connected to each other via connection channels. Here, the outlet of a pump stage is respectively connected to the inlet of the succeeding pump stage via connection channels. Further, the first pump stage in the direction of flow is connected to the pump inlet. The pump inlet has connected thereto the lock chamber or the like to be evacuated. The last pump stage in the direction of flow has connected thereto the pump outlet.

According to the disclosure, the multi-stage rotary piston pump has a large built-in volume ratio. The built-in volume ratio defines the delivery volume of the inlet stage to the delivery volume of the outlet stage. According to the disclosure, the built-in volume ratio is at least 15, preferably at least 20, and particularly preferred at least 25. Due to the provision of a high built-in volume ratio and due to the provision of a multi-stage rotary piston pump it is possible to realize high pumping capacities of in particular at least 1500 m³/h, and in particular more than 2500 m³/h. The built-in volume ratio can be realized by a variation of the length of the stages, and also by a variation of the outer diameter of the rotary pistons as well as the number of teeth, and also by a combination of these variations.

For attaining particularly high pumping capacities, it is particularly preferred that the multi-stage rotary piston pump comprises at least three stages, in particular at least five stages.

Preferably, the following applies to the number of stages

n>\sqrt{VR}−1

wherein

n is the number of stages, and

VR is the built-in volume ratio.

Further, it is preferred to connect at least one of the pump stages to a relief channel for avoiding overcompression, wherein in the relief channel or between the pump stage and the relief channel a relief valve is arranged. Overcompression means the compression of a gas to an intermediate pressure which is higher than the outlet pressure of the pump, i.e. normally everything above 2 bar is considered an overcompression. By reducing the overcompression, the maximum required motor output is decreased.

It is particularly preferred that at least the first two, and in particular the first three pump stages are connected to a relief channel in which, in turn, a corresponding relief valve is arranged. These are the first stages in the direction of flow.

By providing such relief channels it is possible to realize different pumping capacities in the individual successive pump stages. If the pumping capacity of a second stage is smaller than that of a first stage, a portion of the pumped gas can be directly discharged via the relief channel in particular at the beginning of the pump-out phase. Accordingly, depending on the pump-out phase, this is possible at different pumping capacities between the downstream stages.

The multi-stage rotary piston pump according to the disclosure can therefore in particular be operated such that at an initially high pressure of 1000 mbar, for example, the first pump stage discharges the pumped gas in particular completely via the relief channel. At the beginning of the pump-out process, in particular the valve of the first stage is open. During this pumping phase the remaining pump stages are idling, i.e. they deliver small amounts of gas. Even such “idling” stages deliver gas, but due to the relief valves no pressure is built up. At a later time, when the pressure has appropriately decreased, i.e. is 500 mbar, for example, the vent valve connected to the first pump stage is closed and the pumped gas is in particularly completely discharged via the relief channel connected to the second pump stage. The valves of the two and of all further pump stages are open. The remaining pump stages are idling. At a later time, again at a low pressure of 250 mbar, for example, the relief valve connected to the second pump stage is closed and pumping is carried out either via the remaining pump stages or via the third pump stage through a relief channel connected to the third pump stage. The valves of the first and the second pump stage are closed, the valves of the third and possibly further pump stages are open. Depending on the number of stages of the vacuum pump and depending on the number of relief channels connected to the respective pump stages, this can be continued.

The relief channels are preferably connected to the environment and/or the pump outlet. A connection to the pump outlets is in particular advantageous when the pumped gases be cannot directly conducted into the environment because they are toxic or have to be cleaned, for example.

According to another preferred embodiment, the pressure stages or the sizes of the pump chambers where the corresponding rotary piston pairs are arranged for selecting a pump stage, are configured such that the pressure difference between neighboring pump stages is smaller than 500 mbar. Thereby, a decrease of the maximum temperature can be achieved such that in particular due to the provided plurality of pump stages for the overall multi-stage rotary piston pump a very high pumping capacity can be attained.

In addition, for attaining a particularly high pumping capacity, it is advantageous to provide for an efficient cooling. According to a preferred embodiment, the housing therefore comprises cooling fins on its outside and/or cooling channels in the housing walls. A cooling medium, in particular a cooling liquid, flows through the cooling channels. In addition, it is preferred that the connection channels arranged in the housing and to which the pump stages are connected, are arranged in the vicinity of cooling channels. For example, the connection channels can be partially surrounded by cooling channels for attaining a particularly effective cooling.

With regard to the cooling, it is additionally particularly preferred that an inner surface of the pump chambers where the rotary pistons are arranged, is as large as possible. In particular, the following applies:
A>400 mm²/(m³/h)*S/VR, wherein

A is a portion of the inner surface of a pump chamber which preferably has a time-averaged pressure of more than 200 mbar during final-pressure operation,

S is the highest measured pumping capacity of the vacuum pump between inlet pressures at the pump inlet of 1-50 mbar, and

VR is the volume ratio. For realizing correspondingly large surfaces at the given delivery volume, moderate rotational speeds of the rotors are advantageous. In particular, the rotational speed is <6000¹/min, preferably <4500¹/min, particularly preferably <3000¹/min.

In addition, it is preferred that the connection channels have a surface enlarged e.g. by fins for effectively cooling the gas.

According to a particularly preferred embodiment of the disclosure, the gas temperature directly behind the last stage is below 300° C., preferably below 250° C., and particularly preferably below 200° C. when the multi-stage rotary piston pump is operated at the final pressure. These temperatures are measured at an ambient temperature of approximately 20° C. and a coolant inlet temperature of approximately 20° C. as well as at a nominal cooling water flow (i.e. the temperature increase of the cooling water is smaller than 20° C. from inlet to outlet) and operation with air.

In addition, it is preferred that the rotary pistons and preferably also the shafts supporting the rotary pistons are made of a steel alloy or steel. In particular, the combination of steel shaft and aluminum housing is advantageous since the heat expansions coefficients strongly differ from each other.

The housing preferably comprises aluminum or an aluminum alloy.

Particularly preferred are combinations of the aforementioned features since they help to attain a particularly effective suction capacity.

Another essential advantage of the multi-stage rotary piston pump according to the disclosure is that the required installation space can be considerably decreased. The provision of prevacuum pumps is no longer required, or at least smaller prevacuum pumps can be used.

According to another preferred embodiment, the outlet of the first pump stage is connected to a bypass line. In the bypass line, a valve is arranged. The bypass line is in particular connected to the first pump stage. By providing such a bypass line, the first stage can be relieved. Further, it is thereby ensured that the pressure increase in the first pump stage is limited.

According to the disclosure, it is additionally possible to operate the drive motor at a higher output than the nominal output for a short period of time. Thereby, the effectiveness of the pump can be further improved. Here, a drive motor can in particular be operated at a higher output than the nominal output for a period of time of 5 to 30 seconds. In particular, it is possible to increase the output by 50%, preferably by 100% as compared with the nominal output.

### BRIEF DESCRIPTION OF THE DRAWINGS

Hereunder the disclosure will be explained in detail on the basis of a preferred embodiment with reference to the accompanying drawing in which:

FIG. 1 shows a schematic sectional view of a multi-stage rotary piston pump according to the disclosure, and

FIG. 2 shows a schematic cross-section of a rotary piston stage comprising two teeth.

### DETAILED DESCRIPTION OF THE PREFERRED EMBODIMENT

A multi-stage rotary piston pump according to the disclosure comprises a plurality of pump stages 12, 14, 16, 18 in a pump housing 10. Per pump stage, two rotary pistons are provided. Corresponding rotary pistons 20 configured as two-toothed rotary pistons are schematically shown in a cross-sectional view in FIG. 2. The two rotary pistons 20 rotate in opposite directions such that gas is taken in through a gas inlet 24 in a direction indicated by an arrow 22 and is discharged through an opposite outlet 26 in a direction indicated by an arrow 28.

One rotary piston each of the rotary piston pairs is arranged on a common shaft 30 (FIG. 1). Thus the multi-stage rotary piston pump comprises two shafts 30 arranged in series in FIG. 1, said shafts being supported in the housing 10. The shafts are driven by gears 32, for example. The gas to be delivered is taken in via a pump inlet 34 and discharged via a pump outlet 36. The individual stages 12, 14, 16, 18 are respectively connected to each other via connection channels 38. Each pump stage 12, 14, 16, 18 comprises an outlet 40 through which the gas to be delivered is delivered into the connection channel 38. The outlet 42 of the last pump stage 18 is connected to the pump outlet 36. In addition, the pump stages 14, 16, 18 each comprise an inlet 44 which is respectively connected to the corresponding connection channel 38. At each inlet 44 a valve 46, 48, 50, which may be a weight-loaded ball valve, for example, is provided. Via the valves, a connection between the inlets 44 and a relief channel 52 can be established. The first stage 12 can further be connected to a bypass line not shown. Such a bypass line is connected to the outlet 40 of the first stage 12 and comprises a bypass line valve. The bypass line is usually connected to the inlet 34 of the first stage. The relief channel 52 is connected to the pump outlet 36.

Preferably, the pumping capacity of the individual pump stages decreases in the direction of delivery. In particular, the pumping capacity of a succeeding pump stage amounts to half the pumping capacity of the preceding pump stage.

At the pump outlet 36 the pressure usually is approximately 1000 mbar.

The rotary piston pump can be operated in an idealized manner according to the following table when pressure losses in valves and lines are not taken into consideration.

| Pᵢₙ | P₁ | P₂ | P₃ | V₁ | V₂ | V₃ |
|---|---|---|---|---|---|---|
| 1000 | 1000 | 1000 | 1000 | 0 | 0 | 0 |
| 500 | 1000 | 1000 | 1000 | g | 0 | 0 |
| 250 | 500 | 1000 | 1000 | g | g | 0 |
| 125 | 250 | 500 | 1000 | g | g | g |

The table applies to a graduation ratio of 2:1 for each pump stage, i.e. the succeeding stage has half the pumping capacity of the preceding pump stage.

Here, Pᵢₙ is the pressure prevailing at the pump inlet 34. The pressure P₁ is the pressure prevailing at the inlet of the second stage 14 , P₂ is the pressure prevailing at the inlet of the third stage 16, and P₃ is the pressure prevailing at the inlet of the fourth stage 18.

The stated pressures are in mbar.

The valve V₁ is the valve 46, the valve V₂ is the valve 48, and the valve V₃ is the valve 50. “0” means that the valve is open, and “g” means that the valve is closed.

The aforementioned values stated in the table are only exemplary. It is relevant that the pressures are halved from one stage to the next one, depending on which valves are open. Thus the pressure is always halved when the corresponding valve in the stage is closed since the stage only operates when the valve is closed.

1. A multi-stage rotary piston pump comprising two shafts arranged in a housing and supporting a plurality of rotary pistons,
wherein corresponding rotary pistons make up a rotary piston pair, and a plurality of rotary piston pairs each constituting a pump stage are provided,
a plurality of connection channels each connecting neighboring pump stages to each other,
a pump inlet connected to the first pump stage, and
a pump outlet connected to the last pump stage,
wherein
the built-in volume ratio is at least 15.

2. The multi-stage rotary piston pump according to claim 1, wherein the number of stages is at least three.

3. The multi-stage rotary piston pump according to claim 2, the following applies to the number of steps: n>\sqrt{VR}−1 .

4. The multi-stage rotary piston pump according to claim 1, wherein, for avoiding an overcompression, at least one of the pump stages is connected to a relief channel where a relief valve is arranged.

5. The multi-stage rotary piston pump according to claim 1, wherein at least the second and the third pump stages are connected to a relief valve.

6. The multi-stage rotary piston pump according to claim 4, wherein the relief channels are connected to the environment and/or the pump outlet.

7. The multi-stage rotary piston pump according to claim 1, wherein the pressure difference of neighboring pump stages is smaller than 500 mbar.

8. The multi-stage rotary piston pump according to claim 1, wherein the housing comprises cooling fins on an outside and/or cooling channels arranged in housing walls.

9. The multi-stage rotary piston pump according to claim 1, wherein the connection channels are arranged in the housing.

10. The multi-stage rotary piston pump according to claim 1, wherein the pumping capacity of the overall rotary piston pump is at least 1500 m³/h.

11. The multi-stage rotary piston pump according to claim 1, wherein for a surface of a pump chamber where a rotary piston pair is arranged and which has a time-averaged pressure of more than 200 mbar, the following applies:
A>400 mm²/(m³/h)*S/VR, wherein
S is the highest measured pumping capacity of the pump between final pressures of 1-50 mbar, and
VR is the internal volume ratio.

12. The multi-stage rotary piston pump according to claim 1, wherein during the final-pressure operation a gas temperature measured directly behind the last stage is less than 300° C.

13. The multi-stage rotary piston pump according to claim 12, wherein during the final-pressure operation a gas temperature measured directly behind the last stage is less than 250° C.

14. The multi-stage rotary piston pump according to claim 13, wherein during the final-pressure operation a gas temperature measured directly behind the last stage is less than 200° C.

15. The multi-stage rotary piston pump according to claim 10, wherein the pumping capacity of the overall rotary piston pump is at least 2500 m³/h.

16. The multi-stage rotary piston pump according to claim 9, wherein the connection channels are arranged near the cooling channels.

17. The multi-stage rotary piston pump according to claim 2, wherein the number of stages is at least five.

18. The multi-stage rotary piston pump according to claim 1, wherein the built-in volume ratio is at least 20.

19. The multi-stage rotary piston pump according to claim 1, wherein the built-in volume ratio is at least 25.

20. The multi-stage rotary piston pump according to claim 5, wherein at least the second, the third and fourth pump stages are connected to a relief valve.
